(19) United States
(12) Patent Application Publication
(10) Pub. No.: US 2018/0190272 A1
(43) Pub. Date: Jul. 5, 2018

(54) METHOD AND APPARATUS FOR PROCESSING USER INPUT

(71) Applicant: Nuance Communications, Inc., Burlington, MA (US)

(72) Inventors: Munir Nikolai Alexander Georges, Kehl (DE); Eduardo Vellasques, Berlin (DE); Friederike Eva Anabel Niedtner, Montreal (CA); Diana Deokhwa Jung, Lexington, MA (US); Oliver Bender, Aachen (DE); Josef Damianus Anstasiadis, Aachen (DE)

(73) Assignee: Nuance Communications, Inc., Burlington, MA (US)

(21) Appl. No.: 15/740,883

(22) PCT Filed: Jun. 30, 2015
(86) PCT No.: PCT/US2015/038535

§ 371 Date: Dec. 29, 2017

(51) Int. Cl. G10L 15/197; G10L 15/22; G10L 15/04; G10L 25/54

(52) U.S. Cl. CPC G10L 15/197; G10L 25/54; G10L 15/04; G10L 15/22

(57) ABSTRACT

According to some aspects, a method of processing user input received from a user is provided. The method comprises generating a plurality of segmentation hypotheses from content of the user input based, at least in part, on a set of parameters, querying a domain-specific database using each of the plurality of segmentation hypotheses to obtain at least one result, and modifying at least one of the set of parameters based, at least in part, on the at least one result.

### BACKGROUND

Computer systems have been developed that receive input from a user and process the input to understand and respond to the user accordingly. Many such systems allow a user to provide free-form speech input, and are therefore configured to receive speech and employ various resources, either locally or accessible over a network, to attempt to understand the content and intent of the speech input and respond by providing relevant information and/or by performing one or more desired tasks based on the understanding of what the user spoke.

As an example, a user input may include an instruction such as a request (e.g., “Give me driving directions to 472 Commonwealth Avenue,” “Please recommend a nearby Chinese restaurant,” “Listen to Hey Jude from the White album,” etc.), a query (e.g., “Where is the nearest pizza restaurant?” “Who directed Casablanca?” “How do I get to the Mass Pike from here?” “What year did the Rolling Stones release Satisfaction?” etc.), a command (e.g., “Make a reservation at House of Siam for five people at 8 o'clock,” “Watch trailer for The Godfather,” “Call Stephanie,” etc.), or may include other types of instructions to which a user expects the system to meaningfully respond.

User input may be provided as speech input or provided as other types of input such as a text input entered by the user. Independent of the method by which the user input was received, the computer system must ascertain what the user wants and endeavor to respond to the user in a meaningful way. In many instances, the information that a user seeks is stored in a domain-specific database and/or the system may need to obtain information stored in such a database to respond to the user. For example, navigational systems available as on-board systems in a vehicle, stand-alone navigational devices and, increasingly, as a service available via a user's smart phone, typically utilize universal address/point-of-interest (POI) database(s) to provide directions to a location specified by the user (e.g., an address or other POI such as a restaurant or landmark). As another example, queries relating to music may be handled by querying a media database storing, for example, artist, album, title, label and/or genre information, etc., and/or by querying a database storing the user's music library, which may include user-specific information such as user preferences and/or playlists.

Some computer systems, for example, those that implement a general purpose virtual assistant, may need to access multiple databases to be able to respond to a wide variety of inquiries that a user may submit. To do so, the computer system must be configured to appropriately query the pertinent database based on the user input to obtain information responsive to the user. Additionally, database(s) utilized by such systems may change over time, both with respect to the content stored as well as the manner of querying the database(s). To utilize new content and/or appropriately query a database that has been updated in this respect, conventional systems must themselves be updated accordingly, typically requiring expert input to do so.

### SUMMARY

Some embodiments include a method of processing user input received from a user, the method comprising generating a plurality of segmentation hypotheses from content of the user input based, at least in part, on a set of parameters, querying a domain-specific database using each of the plurality of segmentation hypotheses to obtain at least one result, and modifying at least one of the set of parameters based, at least in part, on the at least one result.

Some embodiments include at least one non-transitory computer-readable medium storing instructions that, when executed by at least one processor, perform a method of processing user input received from a user, the method comprising generating a plurality of segmentation hypotheses from content of the user input based, at least in part, on a set of parameters, querying a domain-specific database using each of the plurality of segmentation hypotheses to obtain at least one result, and modifying at least one of the set of parameters based, at least in part, on the at least one result.

Some embodiments include a system for processing user input received from a user, the system comprising at least one processor configured to perform generating a plurality of segmentation hypotheses from content of the user input based, at least in part, on a set of parameters, querying a domain-specific database using each of the plurality of segmentation hypotheses to obtain at least one result, and modifying at least one of the set of parameters based, at least in part, on the at least one result.

### BRIEF DESCRIPTION OF DRAWINGS

Various aspects and embodiments of the application will be described with reference to the following figures. The figures are not necessarily drawn to scale.

FIG. 1 is a schematic diagram of an illustrative computing environment in which some embodiments of the technology described herein may operate.

FIG. 2 is a schematic diagram of a user response system using a conventional technique for producing a database query from user input.

FIG. 3 illustrates a method of segmenting user input into multiple segmentation hypotheses, in accordance with some embodiments.

FIG. 4 is a schematic diagram of a user response system that queries a database using multiple segmentation hypotheses, in accordance with some embodiments.

FIG. 5 is a schematic diagram of a user response system configured to operate with a plurality of content providers, and that queries associated databases using multiple segmentation hypotheses, in accordance with some embodiments.

FIG. 6 is a block diagram of an illustrative computer system that may be used in implementing some embodiments.

### DETAILED DESCRIPTION

As discussed above, a computer system configured to respond to user input (e.g., instructions, requests, commands, queries, questions, inquiries, etc.) should be able to recognize and/or interpret the user input and provide a meaningful response to a wide variety of content. To do so, the system often must access one or more domain-specific databases to obtain information needed to provide a useful response to the user. A domain-specific database refers to any collection of information relevant to a particular domain or multiple domains that is organized and accessible. Thus, a domain-specific database may be, for example, a relatively large database having hundreds, thousands or even millions of entries (e.g., a POI database), an address book or contact list stored on a user's mobile device (e.g., stored on user device 110), music titles in a user's music library (e.g., stored via iTunes), a film database (e.g., imdb.com), a travel database storing flight and/or hotel information, or any other suitable collection of information capable of being queried or otherwise interrogated to obtain information stored therein.

User input is often provided free-form, resulting in a wide variety of input that the computer system must be able to interpret to respond to the user. For example, there are numerous ways that a user might inquire about a POI, many of which may be ambiguous and open to multiple interpretations. As a result, partitioning or segmenting user input into one or more appropriate database queries is often difficult. For example, a user may speak “Find a nearby Boston Market.” This speech input can be interpreted in many ways. The user may be looking for markets in Boston generally or may be looking for the nearest “Boston Market” restaurant. Thus, Boston may be interpreted as a location parameter or as part of a restaurant name. Similarly, market may be interpreted as a type of establishment or as part of a restaurant name. The different interpretations for this instruction map to different database queries and, consequently, will produce different results. Producing incorrect database queries from user input leads to a response that is not helpful to the user.

Conventionally, the process of segmenting user input to produce a database query relies on expert input. In particular, conventional techniques typically employ an expert to train a system for a specific domain prior to deployment. For example, many conventional systems are developed using machine learning techniques (e.g., neural networks, hidden Markov models (HMMs), etc.) implemented by experts (e.g., machine learning experts, domain-specific experts, or both) using training data to train the system to produce appropriate database queries from user input. Obtaining such training data is frequently difficult, often requiring an expert to compile the data, for example, using surveys, or other time and cost intensive processes.

The inventors have recognized that there are a number of drawbacks to this approach. In particular, significant expert resources are needed to produce such a system making this approach costly and time intensive. Requiring expert input to develop a system may be prohibitive for domains having large databases, which could include hundreds of thousands or even millions of entries. Also, a trained system is only as good as the available training data. In many domains (e.g., POIs), the training data is sparse and/or not representative of the full scope of the domain. As a result, systems are frequently trained with a fraction of the training data needed to comprehensively train the system for a particular domain. In addition, training data may be relevant to one database, making it difficult or impossible to re-use training data for other systems accessing other database(s).

In addition, such systems are trained to operate in a specific domain (e.g., to produce queries from user input in connection with a corresponding domain-specific database). Accordingly, relevant components of a user response system must be trained separately for each domain using training data for that specific domain and/or specific database. As such, the time and cost of training a system for deployment must be incurred for each domain of interest. Moreover, expert trained systems are vulnerable to incorrect segmentations for a number of reasons. For example, expert trained systems may produce incorrect segmentations when encountering ambiguous user input subject to multiple interpretations. In addition, a database and/or associated search engine might interpret a domain differently than an expert and therefore the expert trained system may produce queries that are mismatched to the database and/or search engine. Moreover, as no expert can fully (or correctly) characterize entries in a database of appreciable size (e.g., thousands, hundreds of thousands or millions), because databases can be quite complex and/or because in some circumstances no expert may be available for a particular domain, systems that rely on expert training may have substantial and sometimes prohibitive limitations. Furthermore, the conventional approach may be limited to domains in which sufficient training data is available and/or limited to circumstances where expert knowledge of target databases is available. Also, should the domain-specific database be replaced with another, retraining of the system may be required.

The inventors have developed techniques that allow a system to learn how to produce effective queries to one or more appropriate domain-specific databases from user input during operation of the system using information from the database(s). As a result, costly and time-intensive machine learning systems that are trained for a specific domain prior to deployment can be partially or entirely eliminated. In addition, techniques developed by the inventors can be used to produce a system that can learn, during operation of the system, how to effectively query any database. As such, systems incorporating techniques described herein can be applied to any database of interest without needing to pre-train the system using training data specific to the database of interest. Because the system can learn from the database(s) themselves during operation, deployment of the system is not limited to domains for which training data and/or expertise is available.

According to some embodiments, input received by the system from a user is processed by generating a plurality of segmentation hypotheses from content of the user input based, at least in part, on a set of parameters (e.g., one or any combination of rules, scores, statistics, etc., as discussed in further detail below) that instruct or otherwise govern how to produce the plurality of segmentation hypotheses. The plurality of segmentation hypotheses may then be used to query a domain-specific database to ascertain how the database responds to each of the segmentation hypotheses. The results obtained from the domain-specific database responsive to the segmentation hypotheses may be used to modify at least one of the set of parameters. Thus, the system can learn how to appropriately segment user input and, in this respect, can be trained on the fly based on the results obtained from the database, thereby improving in performance as user(s) provide input to the system. In addition, because multiple segmentation hypotheses are utilized, the system is less vulnerable to ambiguous user input.

Following below are more detailed descriptions of various concepts related to, and embodiments of, methods and apparatus for responding to user input. It should be appreciated that various aspects described herein may be implemented in any of numerous ways. Examples of specific implementations are provided herein for illustrative purposes only. In addition, various aspects described in the embodiments below may be used individually or in any combination, and are not limited to the combinations explicitly described herein.

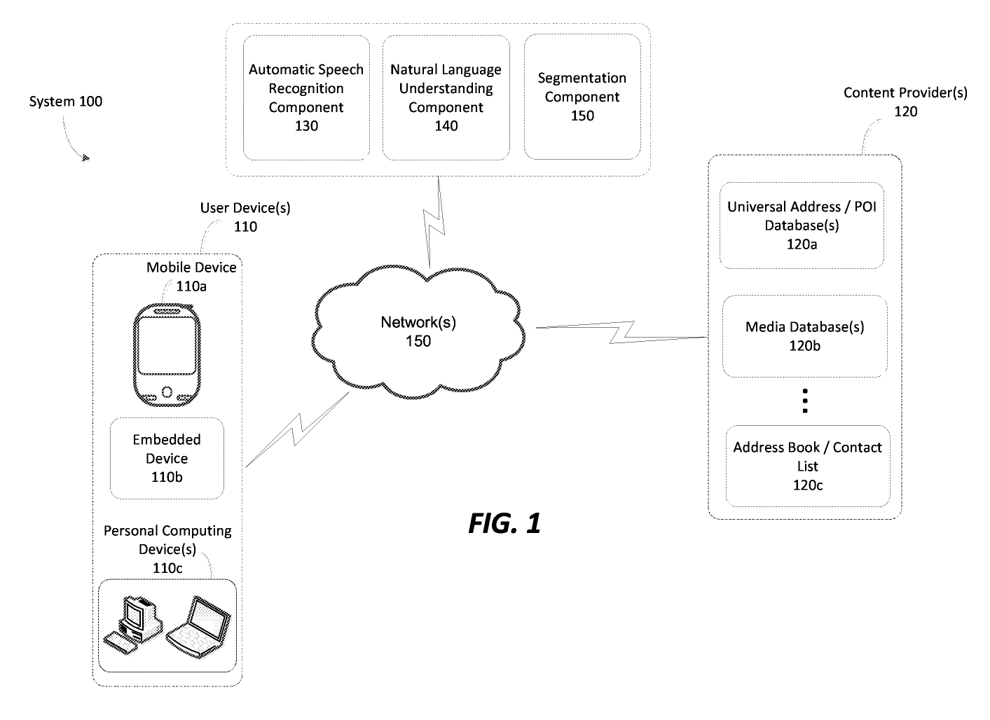

FIG. 1 illustrates a system 100 within which techniques described herein may be implemented. In particular, system 100 may be configured to receive, via any suitable user device 110 of any suitable number or type, user input and process the user input to provide a response to the user. For example, a user device 110 may be a user's mobile device 110a (e.g., a smart phone, personal digital assistant (PDA), wearable device, navigational device, media player, etc.) that allows the user to provide input, for example, using speech or via other suitable methods. Another suitable user device 110 includes an embedded device 110b, such as one or more software and/or hardware components incorporated into an on-board vehicle system or as part of a media system (e.g., an entertainment system, television, media and/or gaming system, a vehicle's on-board entertainment and/or sound system, car head-unit, etc.). A user's personal computing device 110c such as a desktop or laptop computer may also operate as a suitable user device of a user response system. User device 110 may be any one or more computer devices configured to allow users to provide input, as the techniques described herein are not limited for use with any particular type of input device.

According to some embodiments of a user response system, user device 110 may include an application configured to obtain user input and, either alone or in conjunction with one or more network resources, process the user's input and provide a response to the user. The term “user response system” refers to any one or more software and/or hardware components deployed at least partially on or in connection with a user device (e.g., an application resident on user device 110) that is configured to receive and respond to user input. A user response system may be specific to a particular application and/or domain (e.g., navigation, media, etc.), may be a general purpose system that responds to user input across multiple domains, or may be any other system configured to process user input to provide a suitable response (e.g., to provide information, perform one or more actions, etc.).

A user response system may be configured to access and utilize one or more network resources communicatively coupled to (or implemented as part of) the user response system via one or more networks 150, as discussed in further detail below. Thus, actions described as being performed by a user response system are to be understood as being performed local to user input device 110 (e.g., via an application resident thereon) and/or using any one or combination of network resources accessed, utilized or delegated to by the user response system, example resources of which are described in further detail below in connection with the system illustrated in FIG. 1. Thus, according to some embodiments, a user response system may be implemented as a distributed system having at least some functionality implemented on user device 110, and at least some functionality implemented via one or more network resources (e.g., via the cloud). Alternatively, a user response system may be implemented entirely on user device 110, or entirely via the cloud except for minimal input/output capabilities.

User device 110 often (though it need not necessarily) will include one or more wireless communication components. For example, user device 110 may include a wireless transceiver capable of communicating with one or more cellular networks. Alternatively, or in addition to, user device 110 may include a wireless transceiver capable of communicating with one or more other networks or external devices. For example, a wireless communication component of user device 110 may include a component configured to communication via the IEEE 802.11 standard (Wi-Fi) to connect to network access points coupled to one or more networks (e.g., local area networks (LANs), wide area networks (WANs) such as the internet, etc.), and/or may include a Bluetooth® transceiver to connect to a Bluetooth® compatible device, etc. Thus, user device 110 may include one or any combination of components that allow communication with one or more networks, systems and/or other devices. In some embodiments, the user response system may be self-contained and therefore may not need network access.

User device 110 further comprises at least one interface that allows a user to provide input to system 100. For example, user device 110 may be configured to receive speech from a user via one or more microphones such that the speech input can be processed (locally, via one or more network resources, or both) to recognize and understand the content of the speech, as discussed in further detail below. Alternatively, or in addition to, user device 110 may receive input from the user in other ways, such as via any one or combination of input mechanisms suitable for this purpose (e.g., touch sensitive display, keypad, mouse, one or more buttons, etc.).

Suitable user devices 110 will typically be configured to present information to the user. For example, user device 110 may display information to the user via a display, or may also provide information audibly to the user, for example, using speech synthesis techniques. According to some embodiments, information is provided to the user both visually and audibly and may include other mechanisms for providing information to the user, as the aspects are not limited for use with any particular type or technique for providing and/or rendering information to the user in response to user input. As discussed above, a response may be any information provided to a user and/or may involve performing one or more actions or tasks responsive to the user input. The type of response provided will typically depend on the user input received and the type of user response system deployed.

According to some embodiments, a user response system implemented, at least in part, via user device 110 is configured to access, utilize and/or delegate to one or more network resources coupled to network(s) 150, and therefore a user response system may be implemented as a cloud-based solution. Network(s) 150 may be any one or combination of networks interconnecting the various network resources including, but not limited to, any one or combination of LANs, WANs, the internet, private networks, personal networks, etc. The network resources depicted in FIG. 1 are merely exemplary, and a user response system may comprise any one or combination of network resources illustrated in FIG. 1, or may utilize other network resources not illustrated, as techniques described herein are not limited for use with any particular number or configuration of network resources. Among the benefits of a cloud-based solution is the ability to utilize user input from numerous users to improve system performance. In this respect, the system illustrated in FIG. 1 may service numerous user devices 110 receiving input from numerous users. Information gleaned from multiple users may be used to improve the performance of the system or multiple individual systems, as discussed in further detail below.

As discussed above, a user may utilize a user response system to make an inquiry of the system using speech. In this respect, to understand the nature of a user's speech input, such a voice response system may utilize automatic speech recognition (ASR) component 130 and/or natural language understanding (NLU) component 140 that are configured to recognize constituent words and perform some level of semantic understanding (e.g., by classifying, tagging or otherwise categorizing words in the speech input), respectively. Based on the information provided by ASR component 130 and/or NLU component 140, content of the user input may be partitioned to produce an appropriate database query to obtain information to respond to the user. To do so, segmentation component 150 may process content of the user input to segment the content so that a content provider can be effectively interrogated at least in part by producing a query to a domain-specific database that is productive is producing information relevant to responding to the user input, as discussed in further detail below.

The components illustrated in FIG. 1 (e.g., ASR component 130, NLU component 140 and segmentation component 150) may be implemented in software, hardware, or a combination of software and hardware, as separate components, or may be integrated into a single component or a set of distributed components implemented on one or multiple local or network computers (e.g., network servers). While ASR component 130, NLU component 140 and segmentation component 150 are illustrated as connected to user device 110 via network(s) 150, it should be appreciated that one or any combination of these components may be implemented entirely on user device 110, partially on device 110 and partially via one or more network resources, or entirely via one or more network resources, as the techniques described herein are not limited for use to any particular implementation of these components.

The system illustrated in FIG. 1 also comprises a number of exemplary content providers having respective domain-specific databases 120. A content provider may include a search engine associated with a domain-specific database 120, or a search engine may be associated with multiple domain-specific databases 120. Search engine(s) may be implemented separate from or as part of one or more associated domain-specific databases. A domain-specific database refers to any collection of information relevant to a particular domain or multiple domains that is organized and accessible. Thus, a domain-specific database may be, for example, a relatively large database having hundreds, thousands or even millions of entries (e.g., a POI database), an address book or contact list stored on a user's mobile device (e.g., stored on user device 110), music titles in a user's music library (e.g., stored via iTunes), a film database (e.g., imdb.com), a travel database storing flight and/or hotel information, or may be any other suitable collection of information represented in any suitable manner.

In FIG. 1, the exemplary domain-specific databases include one or more universal address/POI database(s) 120a, which may be utilized for navigation assistance, one or more media databases, which can be utilized to respond to user inquiries regarding music, film, etc. and/or one or more address or contact lists associated with the user. However, it should be appreciated that database(s) 120 illustrated in FIG. 1 and described above are merely examples and that techniques described herein may be applied in connection with any one or combination of databases that are available for querying, including network accessible databases and/or databases stored on or as part of a user device 110, as the aspects are not limited in this respect. For example, a navigation system may be operatively coupled to an address/POI database while a general purpose “virtual assistant” may be operatively coupled to multiple (sometimes numerous) domain-specific databases to facilitate obtaining information from a variety of content providers.

To utilize content provider(s) 120, content ascertained from user input is used to produce one or more queries to the appropriate database. To do so, segmentation component 150 receives information from ASR component 130 and/or NLU component 140 and determines how to create a query that will produce results responsive to the user input. For example, NLU component 140 may perform semantic tagging of the words and/or phrases recognized from speech input from the user by ASR component 130. Segmentation component 150 then segments the user input to produce a database query to obtain information needed to respond to the user. As used herein, the term “segmentation” refers to assigning word(s) to categories, columns and/or fields associated with a relevant domain-specific database to produce a query to the database.

As an example, a user driving in Boston may ask the system to “Navigate to the nearest Legal Seafood” using speech. ASR component 130 may be used to recognize the constituent words of the speech input and NLU component 140 and/or segmentation component 150 may identify “Legal Seafood” as a point-of-interest. The system may provide the current location of the user (Boston) to segmentation component 150 to produce a query using “Legal Seafood” as a POI and Boston as a location to obtain the addresses or geo-locations of each Legal Seafood in Boston and compare the results to the user's current location to identify the closest Legal Seafood. The user response system may then provide navigation directions to the user based on the results obtained from the database.

It should be appreciated that when user input is provided in some manner other than speech (e.g., via text input), ASR component 130 may not be necessary. Furthermore, the constituent components of the may be implemented in any way. While the exemplary illustration in FIG. 1 separates components functionally, these components may be realized in any number of ways. For example, NLU component 140 and segmentation component 150 may be a single component or may comprise multiple components to perform the desired functionality. That is, aspects of NLU component 140 and segmentation component 150 may be a single integrated component or the desired functionality may be implemented by multiple components that can be separated architecturally and/or geographically in any manner. Similarly, ASR component 130 may be implemented as a separate component and/or integrated with NLU component 140 and/or segmentation component 150 in any suitable manner.

It should be further appreciated that the various components illustrated in FIG. 1 may be coupled in any suitable manner, and may be components that are located on the same physical computing system(s) or separate physical computing systems that can be coupled in any suitable way, including using any type of network, such as a local network, a wide area network, the internet, etc. For example, domain-specific databases may be network resources accessible via the network or may be stored, partially or entirely, on or as part of a user device 110. Similarly, ASR component 130, NLU component 140 and/or segmentation component 150 may be implemented locally, remotely or a combination thereof, and may implemented as separate or integrated components.

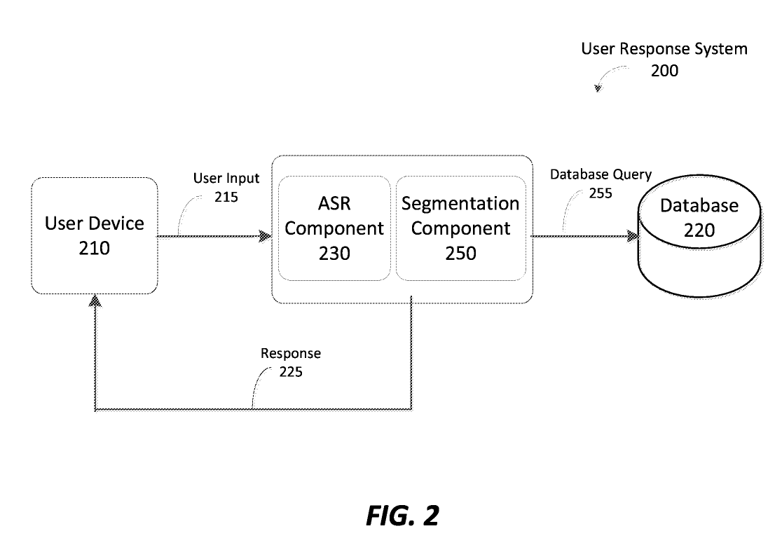

Due to the variety in which user's may phrase input to the system and due to the ambiguity of language generally, particularly in certain domains, ascertaining the meaning and intent of user input and producing effective queries to the appropriate database(s) to meaningfully respond to the user can be difficult. As discussed above, segmenting the content of user input to appropriate database queries is conventionally achieved using expert input and specially trained components. FIG. 2 illustrates schematically a conventional manner of providing a user response system. In the user response system illustrated in FIG. 2, a user provides user input 215 via user device 210, for example, speech input via a mobile communication device. If the input is speech, user input 215 may be received by ASR component 230 to recognize the constituent words of the speech input. When the user input is something other than speech (e.g., a text input), user input 215 may be processed directly by segmentation component 250. Conventional segmentation component 250 ascertains content of the user input 215 and segments user input 215 to produce a database query to an appropriate domain-specific database. In this respect, segmentation component 240 may include suitable natural language processing (NLP) techniques or may include or make use of information from an NLU component such as NLU component 140 illustrated in FIG. 1.

As discussed above, conventional systems rely on expert developed models trained prior to deployment of the system to learn how to generate productive database queries from the content of user input. As such, conventional segmentation components are trained to produce a single partitioning or segmentation of the user input, which is then used to perform one or more database queries 255 to obtain results to use in responding to the user. The results obtained from querying database(s) 220 are then used to generate a response to the user input, schematically illustrated as response 225 provided to user device 210 for presentation to the user. Response 225 may include one or more results from database(s) 220, with or without post-processing by the system (e.g., ranking, labeling from segmentation information, etc.). Response 225 may also include one or more actions taken by the system based on the results obtained from database(s) 220.

Based on the insight that the content providers themselves may be used to learn how to produce effective database queries to the associated domain-specific databases, the inventors have developed a data driven approach to segmenting user input. According to some embodiments, user input is processed to produce multiple segmentation hypotheses that are used to interrogate a content provider, for example, by using the segmentation hypotheses as query to an appropriate domain-specific database. The results of the queries may be used to update, adjust or modify segmentation so that segmentation learns how to segment user input based how corresponding domain-specific database(s) respond to the segmentation hypotheses. According to some embodiments, the techniques described herein allow a segmentation component to be implemented without the significant time and cost investment of conventional expert trained segmentation components.

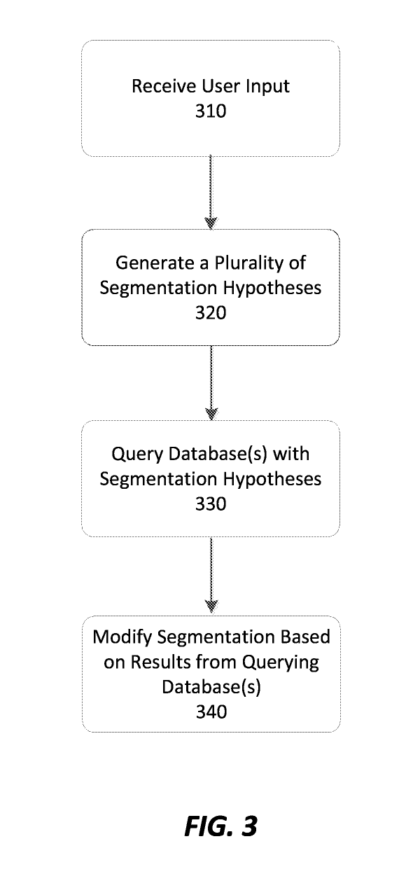

FIG. 3 illustrates a method of improving segmentation of user input in a user response system, in accordance with some embodiments. In act 310, user input is received (e.g., via a user device 110). As discussed above, user input may be provided as speech (e.g., free-form speech provided via a user device) or may be provided in a different way, such as a text input via a keyboard, keypad, touch screen or any other suitable mechanism. The user input may then be processed to ascertain content of the user input to obtain information from one or more content providers to facilitate responding to the user in a meaningful manner.

In act 320, the user input is segmented to generate a plurality of segmentation hypotheses. The segmentation hypotheses may be generated with or without the assistance of NLP/NLU techniques. For example, segmentation may be assisted by an NLU component configured to perform semantic tagging of constituent words or phrases in the user input, or segmentation may be performed by permuting or combining words or phrases in the user input without first tagging or otherwise classifying the constituent words, as discussed in further detail below. Segmentation may be performed using a set of parameters that govern how the multiple segmentation hypotheses are generated. Initially, the set of parameters may include rules on how to permute words in the user input and/or how to utilize information from semantic tagging or elsewhere to instruct the segmentation. The set of parameters may also include scores (e.g., counts, rankings, likelihoods, etc.) associated with segmentation hypotheses based on results obtained using the respective segmentation hypotheses, as discussed in further detail below. In act 330, each segmentation hypothesis may be used to interrogate a content provider to obtain information to assist in responding to the user. For example, each segmentation hypothesis may form a query to a domain-specific database pertinent to the user input so that relevant information may be obtained.

In act 340, the results obtained by querying the domain-specific database are used to modify at least one aspect of segmentation to affect the performance thereof. For example, results obtained responsive to each segmentation hypothesis may be used to create, adjust and/or update at least one parameter associated with one or more segmentation hypotheses. The at least one parameter may include a score corresponding to one or more respective segmentation hypotheses and/or individual segments of the respective segmentation hypotheses. The at least one parameter may include one or more rules used to generate segmentation hypotheses, or may include a likelihood, probability or weight associated with segments of respective segmentation hypotheses, or any other suitable parameter that affects segmentation. In general, segmentation may be modified in any manner so that subsequent segmentation favors segmentation hypotheses that were effective in producing results.

As one example, segmentation hypotheses may be scored based on whether and how many results were obtained by querying the domain-specific database with the respective segmentation hypothesis. The scores may be maintained and updated during operation so that productive segmentation hypotheses and segments thereof receive higher scores. As another example, segmentation may be implemented as a finite state transducer (FST), such as a weighted FST, and the results obtained by querying domain-specific database(s) may be used to weight the FST such that paths through the FST corresponding to productive segmentation hypotheses receive higher scores (or have lower associated costs). As another example, segments of respective segmentation hypotheses may be recorded and the likelihood increased for segments of segmentation hypotheses that returned results when used to query one or more domain-specific database(s). It should be appreciated that how the results are used to modify segmentation may depend on how segmentation is implemented, and the techniques described herein are not limited for use with any particular implementation or manner of modifying segmentation.

Results obtained from querying an appropriate database may also be used to respond to the user. For example, the results may be analyzed to determine which of the segmentation hypotheses returned results. If multiple queries were productive, and results may be ranked according to a desired criteria (e.g., based on number of results, based on a user profile or knowledge about user preference, knowledge about the domain, etc.). As discussed above, a response to the user may be of any type and may depend on the content of the user input. A response may include providing information to the user based on the results obtained from querying the domain-specific database. For example, the system may respond to a user requesting the address of a POI by providing the corresponding address. The system may respond to a request for driving directions to a POI with navigation instructions. Alternatively or in addition to, a response may include performing one or more actions. For example, the system may respond to a user requesting to listen to a song title by playing the song on an available media player. When multiple results are obtained responsive to the database queries, the system may choose results corresponding to one of the queries and provide a response to the user based on the chosen results and/or the system may provide a response that includes information pertaining to multiple results and allow the user to make a selection to which the system can respond accordingly. A response to the user can take any form, as the aspects are not limited in this respect. The method described in the foregoing facilitates deployment of a user response system that can reduce or eliminate the need for expert derived components that are trained prior to deployment to segment user input into an appropriate database query, examples of such systems are described in further detail below.

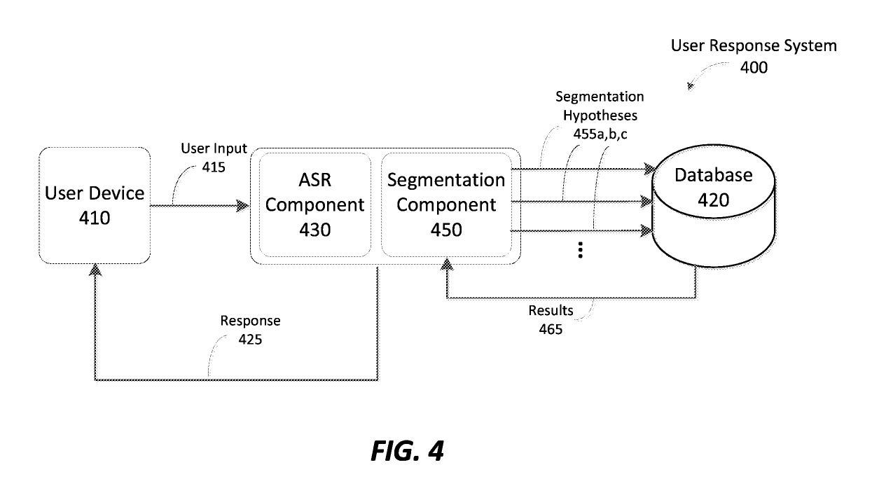

FIG. 4 schematically illustrates an exemplary user response system implementing one or more techniques described above in connection with FIG. 3. User response system 400 may be similar to user response system 300 in that user input 415 provided via user device 410 is received by a segmentation component 450, which may first be processed by ASR component 430 (and/or an NLU component if implemented separately from the segmentation component) when the user input is provided as a speech input. In contrast to the conventional segmentation component 250 illustrated in FIG. 2, segmentation component 450 is configured interrogate an appropriate content provider by generating multiple segmentation hypotheses 455 from content of the user input. The multiple segmentation hypotheses may then be used to query domain-specific database 420 to obtain information that may be used to respond to the user. Results 465 obtained from querying domain-specific database 420 may be used to modify one or more aspects of segmentation component 450 to learn which segmentations are effective and which are not. In this respect, segmentation component 450 can learn and improve during operation from the database itself and, in some embodiments, can be implemented with relatively minimal or no expert involvement and/or training beforehand. Thus, segmentation component 450 may be implemented even in instances where training data and/or expert input is not available or desirable.

As an example, a user may provide speech input to user response system 400 and ASR component 430 may be utilized to identify the content of the speech (e.g., by recognizing the constituent words in the speech input). For example, a user may speak a free-form instruction to user device 410 such as “Driving directions to Legal Seafood in Boston.” The speech input may be received by the user response system and provided to ASR component 430 to be recognized. The free-form instruction may be processed in any suitable manner prior to providing the free-form instruction to ASR component 430. For example, the free-form instruction may be pre-processed to remove information, format the free-form instruction or modify the free-from instruction in preparation for ASR (e.g., the free-form instruction may be formatted to conform with a desired audio format and/or prepared for streaming as an audio stream or prepared as an appropriate audio file) so that the free-form instruction can be provided as an audio input to ASR component 430 (e.g., provided locally or transmitted over a network). ASR component 430 may be configured to process the received audio input (e.g., audio input representing free-form instruction) to form a textual representation of the audio input (e.g., a textual representation of the constituent words in the free-form instruction that can be further processed to understand the meaning of the speech input) or any other suitable representation of the content of the speech input.

ASR component 430 may transmit or otherwise provide the recognized input to segmentation component 450 to segment the input. Segmentation component 450 may use any suitable language understanding techniques to ascertain the content of the user input so as to facilitate responding to the user (e.g., in determining driving directions to the requested locale and providing the driving directions to the user). For example, segmentation component 450 may be configured to identify and extract grammatical and/or syntactical components of the free-form speech, such as carrier phrases, filler and/or stop words. Carrier phrases refer generally to words or phrases a user uses to give context to the user input but that typically are not relevant for purposes of the database query, but may be relevant for other purposes such as establishing intent. Filler and stop words refer to articles, prepositions and other words that make a sentence grammatically correct but are typically not relevant to a querying a database. In this respect, segmentation component 450 may comprise an NLU component and/or may make use of information provided by a separate NLU component (e.g., NLU component 140 illustrated in FIG. 1).

The word content remaining in the user input after removing certain words or phrases may be used to produce multiple segmentation hypotheses. According to some embodiments, the entire user input is utilized to generate segmentation hypotheses without first identifying and removing carrier phrases, filler and/or stop words. In this respect, some embodiments of a user response system may not use NLU or may rely on NLU in a minimal capacity. It should be appreciated, however, that the extent to which NLU is employed is not a limitation, as different embodiments will utilize an NLU component, either separate from or integrated with ASR component 430 and/or segmentation component 450, to differing extents, including embodiments that do not utilize an NLU component.

In the example given above, segmentation component 450 may utilize NLU to identify “Driving directions to” as the carrier phrase indicating that the user is seeking navigational assistance. In systems that service multiple domains (e.g., a general purpose virtual assistant), the carrier phrase may be processed to evaluate intent, for example, to determine the domain to which the user input pertains, as discussed in further detail below. For dedicated systems (e.g., single domain systems), the domain may be implied by the application being used. Once the carrier phrase is identified and/or one or more filler or stop words removed (e.g., the word “in” in the above example user input of “Driving directions to Legal Seafood in Boston”), the remaining content may be used to generate multiple segmentation hypotheses. In some embodiments, stop words that are not identified prior to segmentation may be identified via analyzing the results obtained using segmentation hypotheses that include such words, as discussed in further detail below.

In some embodiments, segmentation component 450 generates multiple segmentation hypotheses by permuting the words of the user input, either with or without first removing certain portions of the user input. For example, assume that in the above example, the system communicates with a POI database that can be queried according to specified fields of the database. POI database may be responsive, for example, to queries of the form <entity name>, <location>, wherein the entity name is the field storing the name of the POI for records stored in the database and the location is the field storing the geographical area pertinent to the POI in the corresponding record. Table 1 below illustrates an exemplary set of segmentation hypotheses generated by forming a number of permutations of the words “Legal,” “Seafood” and “Boston” of the user input.

TABLE 1

| <entity name> | <location> |
|---|---|
| Legal Seafood Boston | |
| Legal Seafood | Boston |
| Legal | Seafood Boston |
| | Legal Seafood Boston |
| Boston | Legal Seafood |
| Seafood Boston | Legal |

Each of the six exemplary segmentation hypotheses have a pair of n-gram segments corresponding respectively to hypotheses for the <entity name> and <location> fields of domain-specific database 420. The segmentation hypotheses may be used to query domain-specific database 420 to obtain results that can be used to respond to the user. In this example, because the segmentation hypotheses are generated by permuting the words in the user input, an expert trained component may not be needed to segment the relevant content in the user input. However, because of the manner that segmentation hypotheses are generated, some hypotheses will likely not generate results. Whether a segmentation hypothesis generates results when used to query a database can be used to improve segmentation. For example, the segmentation hypothesis Legal Seafood, Boston should return a number of results, for example, results including an address for each of the Legal Seafood restaurants in Boston (e.g., results 465 will likely include information stored in association with one or more records for Legal Seafood). As a result, the hypothesis that “Legal Seafood” is an entity name and “Boston” is a location may be scored so that subsequent segmentations favor the segments in this hypothesis.

According to some embodiments, segmentation component 450 keeps a record of segmentation hypotheses that have been generated and maintains a score associated with each segment for recorded segmentation hypotheses. The score may be any likelihood, probability or other measure indicating how productive queries using that segmentation hypothesis are in returning results. When a segmentation hypothesis returns results, the score associated with each segment in the productive hypothesis may be increased. According to some embodiments, segmentation component 450 may maintain a score for each segment and additionally store an indication of combinations of segments that formed successful segmentation hypotheses. In some embodiments, scores for productive segments are maintained without maintaining information regarding combinations of the segments. When segmentation component 450 generates a segmentation hypothesis with one or more segments that have not yet been recorded, segmentation component 450 may store the segments of the segmentation hypothesis if the hypothesis returns results, otherwise the new segments of the segmentation hypothesis may be discarded. Though, in some embodiments, unproductive segmentation hypotheses may be recorded, e.g., with a score of zero or other indication that the segmentation hypothesis did not produce useable or suitable results (including no results at all) so that the segmentation hypothesis can be avoided in future segmentations.

According to some embodiments, segmentation component 450 may be implemented as an FST that is updated based on whether segmentation hypotheses are productive when used to query a database. For example, the FST may encode segments of generated segmentation hypotheses and results obtained from querying the database can be used to increase the score that results from paths through the FST that include segments and/or produce segmentation hypotheses that have been productive in the past. In this way, segmentation component 450 may learn from successful database queries by modifying the FST. New segmentation hypotheses can be added to the FST and whether the segmentation hypotheses are productive can be encoded by the FST to improve the ability of segmentation component 450 to generate productive segmentation hypotheses.

By using any of the above described techniques, segmentation component 450 may be trained using results from database queries. Thus, the database may be used to drive the learning. This data driven approach to learning reduces or eliminates the need for expert involvement in training segmentation components. It should be appreciated that any suitable technique and/or construct may be used to generate segmentation hypotheses and learn from the results returned in response to querying the database using the segmentation hypotheses, as the technique of using the database to learn appropriate segmentations is not limited for use with any particular learning technique or construct for doing so.

As discussed above, NLP techniques may be utilized to limit the number of segmentation hypotheses used to query a corresponding database. For example, semantic tagging may be employed to eliminate some permutations as viable segmentation hypotheses. In particular, a user may speak the request “Find the nearest New York Pizza in Boston.” A semantic tagger, either implemented as a separate component or integrated with ASR component 430, segmentation component 450, or both, may process the input to tag words of the user input. For example, a semantic tagger may parse the input as follows “Find the nearest {carrier phrase} New York {location} Pizza {food} in {filler word} Boston {location}.” Segmentation component 450 can use this information to reduce the number of segmentation hypotheses by only generating those hypotheses with segments identified as locations placed in the <location> field of the database query. As such, segmentation component 450 may generate the following segmentation hypotheses, while eliminating others that are inconsistent with the semantic tagging.

TABLE 2

| <entity name> | <location> |
|---|---|
| New York Pizza | Boston |
| Pizza Boston | New York |

Thus, the segmentation hypotheses can be limited by knowledge provided using one or more NLU techniques. Some embodiments may not employ NLU to identify filler or stop words, or in some instances these words may be overlooked or mischaracterized by the NLU techniques that are implemented. The inventors have recognized that the technique of generating multiple segmentation hypotheses can be used to identify filler or stop words so that they can be eliminated or ignored. For example, a segmentation component may generate segmentation hypotheses by permuting words in a user input, including one or more filler or stop words, which may be represented as unigram segments or as part of one or more n-gram segments. When such segments are repeatedly unproductive when used to query one or more databases, the system may identify them as filler or stop words that can be removed or ignored in subsequent segmentations. On the other hand, some filler words may be important parts of productive segmentation hypotheses and the system can identify such words based on productive queries resulting from segments that include such words. The system may then subsequently favor segments that include such words, typically as part of an n-gram segment having one or more other words that together were previously successful in obtaining results.

Response 425 may be provided to the user based on results from the database. Response 425 may include any information in any suitable format that conveys relevant information to a user. For example, response 425 may include one or more results from database(s) 420, with or without post-processing by the system (e.g., ranking, labeling, etc.). Response 425 may also include one or more actions taken by the system based on the results obtained from database(s) 420. Response 425 may include one or more questions posed to the user to solicit further information from the user needed to meaningfully respond to the user input, or may include other information (such as an alternative suggestion), as the aspects are not limited to the manner in which the system responds to the user.

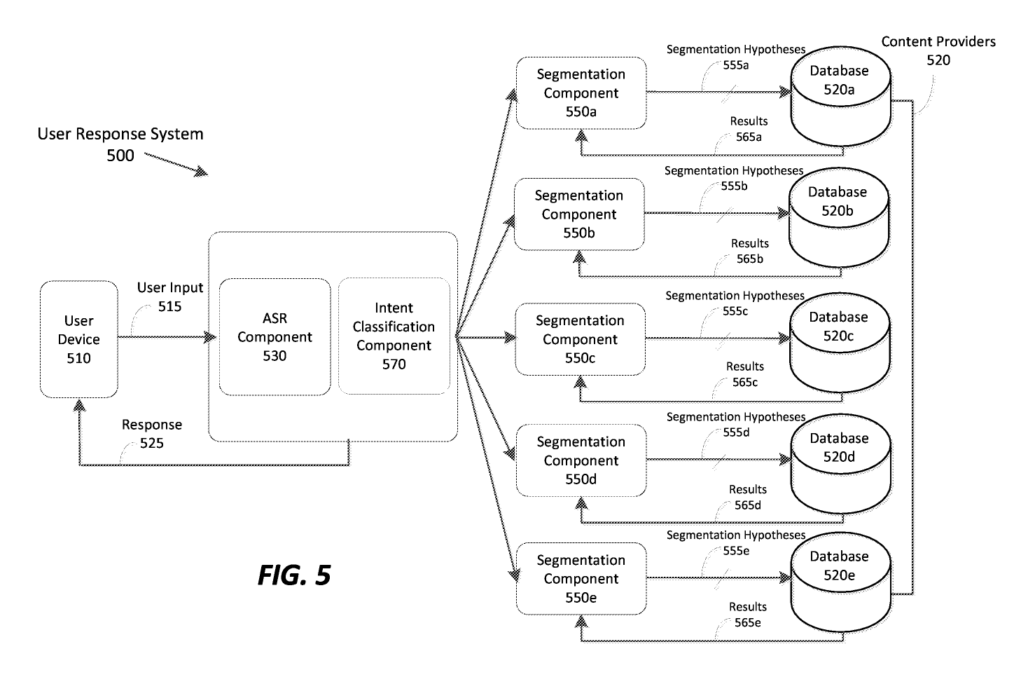

In the system illustrated in FIG. 4, a single segmentation component 450 and database are illustrated. However, a system for responding to user input may be configured to operate in multiple domains by obtaining information from multiple content providers, each of which may have an associated domain-specific database. In such systems, each domain may include a separate segmentation component 450 that learns how to generate segmentations for the respective domain. FIG. 5 illustrates schematically a user response system capable of providing assistance in multiple domains, at least in part by being configured to query multiple content providers to assist in responding to users. For example, user response system 500 may be a “virtual assistant” designed to assist with a variety of inquiries from its user(s). To be able to meaningfully respond to user input such as “Watch trailer for On the Waterfront,” “Where is the nearest gas station?”, “What is the temperature in Orlando?” “Listen to Rolling in the Deep by Adele,” “Send a text to John,” a user response system may need to operate with a number of content providers.

User response system 500 may be similar in many respects to user response system 400 illustrated in FIG. 4. However, user response system 500 is operatively coupled to a plurality of content providers 520 such that domain-specific databases may be queried for a number of different domains. For example, exemplary user response system 500 may be coupled to a universal address/POI database 520a, a music database 520b, a film data base 520c, a meteorological database 520d and a contact list 520e. It should be appreciated that the non-limiting list of databases is provided for illustration only, and a user response system may be coupled to any number of content providers of any type, as the aspects are not limited in this respect. Each domain includes a respective segmentation component 550 that may perform any one or combination of techniques described herein. Thus, user response system 500 can learn how to segment user input for a plurality of domains using results obtained from respective content providers. While the content providers are illustrated as being external to user device 510, any one or combination of content providers may be resident on user device 510 and/or have one or more local components (e.g., contact list 520e may be resident on a mobile device 510 of the user). Similarly, search engines may be separate from one or more associated databases, which themselves may be implemented local to the user device or accessible via the cloud.

In user response system 500, an intent classification component 570 is provided to determine to which domain user input pertains. User intent classification component 570 may be part of an NLU component configured to identify carrier phrases, filler or stops words, etc. and/or configured to perform semantic tagging. For example, identified carrier phrases may be processed by intent classification component 570 to determine the relevant domain so that the appropriate segmentation component can be selected to generate segmentation hypotheses with which to interrogate the respective content provider for the relevant domain. In embodiments that include semantic tagging, intent classification component 570 may also utilize the tags (or may itself perform tagging) to determine the appropriate domain.

For example, intent classification component 570 may use knowledge representation models that capture semantic knowledge regarding language and that may be capable of associating terms in the user input with corresponding categories, classifications or types so that the domain of the request can be identified. With reference to the example user input “Driving direction to Legal Seafood in Boston,” intent classification component 570 may ascertain from knowledge of the meaning of the terms “driving” and/or “directions” that the user's inquiry pertains to navigation and therefore select segmentation component 550a to produce segmentation hypotheses to query universal address/POI database 520a. Words such as “where” also may provide a cue that user input pertains to navigation or POI identification or location determination. Regarding other examples given above, identification of the verb “watch” may provide indication that the user is interested in video and the word “trailer” may indicate that the user is interested in watching a movie trailer. Similarly, the verb “listen” may be identified by intent classification component 570 to ascertain that the user input pertains to music. It should be appreciated that intent classification component 570 can utilize any information to facilitate identifying the domain to which the user input pertains, as the aspects are not limited in this respect.

Upon determining the relevant domain, the corresponding segmentation component 550 may be selected to generate segmentation hypotheses with which to interrogate the corresponding content provider, at least in part, by issuing queries to the associated domain-specific database to obtain information to assist in responding to the user and to update the corresponding segmentation component using any of the techniques described above. Alternatively, the relevant domain can be identified using segmentation component 550. For example, if segmentation does not produce candidates for one or more fields corresponding to a domain-specific database, it may be concluded that the user input does not correspond to that domain. In this manner, segmentation component 550 may be used in place of, or in combination with, intent classification 570 to determine the domain pertinent to the user input.

While the segmentation component(s) 550 are illustrated schematically in FIG. 5 as separate components, this is merely to demonstrate that segmentation may be performed for multiple domains. It should be appreciated that a segmentation component can be implemented in any manner, for example, as a single component configured to segment user input in multiple domains or as separate components configured for one or more respective databases. The one or more segmentation components may reside locally on a user device, may be provided as a network resource, or a combination of both. Additionally, one or more segmentation components may be implemented as part of, or separate from, components performing ASR and/or NLU, as the techniques described herein are not limited for use with any particular implementation.

It should be appreciated that, in some embodiments, NLU components such as intent classification component 570 may be shared across multiple domains and may need little or no customization for each domain of interest. As such, general purpose NLU components that have been developed for other natural language understanding applications may be utilized with minimal customization, and in some cases, no or minimal domain specific customization, to assist in intent classification and/or semantic tagging. While such NLU components may be the result of expert trained systems, suitable NLU components are widely available and can be adapted for a user response system with reasonable and in many cases a relatively small amount of effort. It should be further appreciated that the techniques described herein are robust to changes in the domain-specific databases used by the system. Because expert knowledge in this respect is not required, updates to relevant databases or a change of database entirely is handled by the system because the system learns from the databases themselves.

As discussed above, a user response system that receives and processes user input to provide information in response may be a cloud-based solution so that user input from multiple users may be used to improve system performance. For example, user input received from any number of users via any number of respective user devices may be used to update one or more relevant segmentation components. Together, this information may quickly allow the user response system(s) to learn how to segment user input during operation, without the need to have an expert trained system developed and trained beforehand to do so. Further, as also discussed in the forgoing, the components of the system may be implemented as separate component, integrated in any manner and may reside on the user device, on one or more network computers, or a combination of both. Similarly, content providers may be databases resident on the user device (e.g., a contact list, a user's media library, etc.), may reside in the cloud or a combination of both.

As discussed above, as the user response system is utilized, segmentation learns how to segment user input correctly to generate productive database queries. In this respect, a segmentation component may be trained on the fly with minimal or without expert input using the techniques described in the foregoing. Once a segmentation component (or multiple segmentation components) has learned to generate productive database queries, the “trained” segmentation component can be utilized without using database queries to identify the correct segmentation, as the set of parameters (e.g., statistics, weights, rules, etc.) used for segmentation has been modified during operation to generate productive queries. A segmentation component “trained” using the techniques described herein can be utilized as a segmentation component in another system that has not been configured according to these techniques, thereby enjoying the benefit of a trained segmentation component.

Additionally, a segmentation component trained using the techniques described herein can provide support to a user even when the pertinent database is unavailable. For example, using the example user input of “Where is the nearest Legal Seafood in Boston?”, the relevant POI database may be temporarily inaccessible, but the segmentation component can still segment the user input correctly with Legal Seafood as a restaurant and Boston as a location. When the system identifies that the corresponding database in not accessible, the system may provide a response to the user indicating that the restaurant database is not available and inquire whether the user would like a web search for Legal Seafood restaurants in the Boston area. Thus, the user response system may be able to provide useable results to the user via the trained segmentation component even though the relevant database is unavailable.

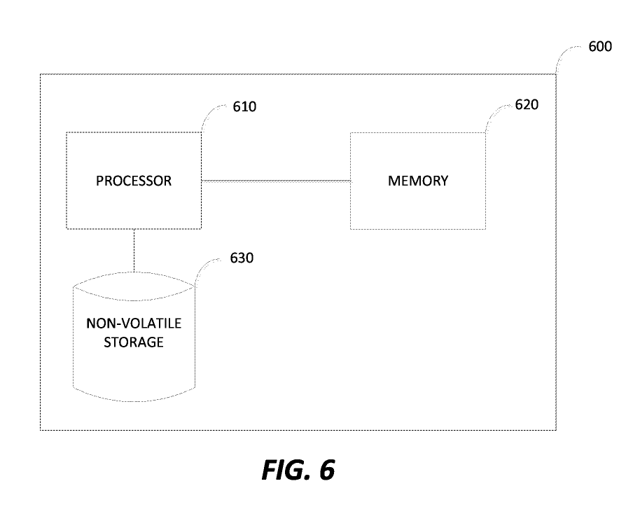

An illustrative implementation of a computer system 600 that may be used to implement one or more of the techniques described herein is shown in FIG. 6. For example, a computer system 600 may be used to implement one or more components illustrated in FIG. 1 and/or to perform one or more techniques described in connection with FIGS. 3-5. Computer system 600 may include one or more processors 610 and one or more non-transitory computer-readable storage media (e.g., memory 620 and one or more non-volatile storage media 630). The processor 610 may control writing data to and reading data from the memory 620 and the non-volatile storage device 630 in any suitable manner, as the aspects of the invention described herein are not limited in this respect. Processor 610, for example, may be a processor on a mobile device, a personal computer, a server, an embedded system, etc.

To perform functionality and/or techniques described herein, the processor 610 may execute one or more instructions stored in one or more computer-readable storage media (e.g., the memory 620, storage media, etc.), which may serve as non-transitory computer-readable storage media storing instructions for execution by processor 610. Computer system 600 may also include any other processor, controller or control unit needed to route data, perform computations, perform I/O functionality, etc. For example, computer system 600 may include any number and type of input functionality to receive data and/or may include any number and type of output functionality to provide data, and may include control apparatus to perform I/O functionality.

In connection with processing received user input, one or more programs configured to receive user input, process the input or otherwise execute functionality described herein may be stored on one or more computer-readable storage media of computer system 600. In particular, some portions or all of a user response system, such as a voice response system, configured to receive and respond to user input may be implemented as instructions stored on one or more computer-readable storage media. Processor 610 may execute any one or combination of such programs that are available to the processor by being stored locally on computer system 600 or accessible over a network. Any other software, programs or instructions described herein may also be stored and executed by computer system 600. Computer system 600 may represent the computer system on user input device and/or may represent the computer system on which any one or combination of network components are implemented (e.g., any one or combination of components forming a user response system, or other network resource). Computer system 600 may be implemented as a standalone computer, server, part of a distributed computing system, and may be connected to a network and capable of accessing resources over the network and/or communicate with one or more other computers connected to the network (e.g., computer system 600 may be used to implement any one or combination of components illustrated in FIG. 1, 4 or 5).

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which multiple examples have been provided. The acts performed as part of each process may be ordered in any suitable way. Accordingly, embodiments may be constructed in which acts are performed in an order different than illustrated, which may include performing some acts concurrently, even though shown as sequential acts in illustrative embodiments.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A method of processing user input received from a user, the method comprising:
generating a plurality of segmentation hypotheses from content of the user input based, at least in part, on a set of parameters;
querying a domain-specific database using each of the plurality of segmentation hypotheses to obtain at least one result; and
modifying at least one of the set of parameters based, at least in part, on the at least one result.

2. The method of claim 1, wherein the set of parameters includes at least one rule regarding generating the plurality of segmentation hypotheses.

3. The method of claim 1, wherein the set of parameters includes at least one score associated with at least one of the plurality of segmentation hypotheses, and wherein modifying at least one of the set of parameters includes updating the at least one score based on the at least one result.

4. The method of claim 3, wherein each segmentation hypothesis for which one or more results are produced in response to querying the domain-specific database using the respective segmentation hypothesis is stored in association with a respective score.

5. The method of claim 4, wherein each segment of each segmentation hypothesis for which one or more results are produced in response to querying the domain-specific database using the respective segmentation hypothesis is stored in association with a respective score, and wherein modifying at least one of the set of parameters comprises modifying the score associated with each stored segment when the respective segment is part of a segmentation hypothesis producing one or more results.

6. The method of claim 1, wherein the set of parameters include one or more statistical grammars.

7. The method of claim 6, wherein the one or more statistical grammars are realized by a weighted finite state transducer.

8. The method of claim 1, wherein each of the plurality of segmentation hypotheses comprises at least one n-gram segment, and wherein the set of parameters includes n-gram statistics indicative of how effective each n-gram segment has been in producing results when included in a segmentation hypothesis used to query the domain-specific database, and wherein modifying at least one of the set of parameters includes updating the n-gram statistics based on the at least one result.

9. The method of claim 1, wherein modifying at least one of the set of parameters is based, at least in part, on a number of respective results obtained responsive to each of the plurality of segmentation hypotheses.

10. The method of claim 1, wherein at least one of the set of parameters is modified to positively bias at least a segmentation hypothesis that produced a highest number of results when used to query the domain-specific database.

11. The method of claim 1, wherein at least one of the set of parameters is modified to negatively bias segmentation hypotheses that produced no suitable results when used to query the domain-specific database.

12. The method of claim 1, further comprising selecting the domain-specific database from a plurality of available domain-specific databases based, at least in part, on analyzing content of the user input.

13. The method of claim 12, wherein the user input is a speech input, the method further comprising performing automatic speech recognition on the speech input to provide a textual representation of the content of the user input.

14. The method of claim 1, further comprising identifying at least one carrier word in the user input.

15. The method of claim 1, further comprising identifying at least one stop word in the user input based, at least in part, on the at least one result.

16. The method of claim 1, wherein the domain-specific database includes a point-of-interest database, a media database including song titles and/or film titles, a contact list, an address list or a telephone directory.

17. The method of claim 1, further comprising providing a response to the user based, at least in part, on the at least one result.

18. (canceled)

19. (canceled)

20. The method of claim 1, wherein providing a response to the user includes performing at least one action based, at least in part, on the plurality of results.

21. A system for processing user input received from a user, the system comprising:
at least one processor configured to perform:
generating a plurality of segmentation hypotheses from content of the user input based, at least in part, on a set of parameters;
querying a domain-specific database using each of the plurality of segmentation hypotheses to obtain at least one result; and
modifying at least one of the set of parameters based, at least in part, on the at least one result.

22. At least one non-transitory computer-readable medium storing instructions that, when executed by at least one processor, perform a method of processing user input received from a user, the method comprising:
generating a plurality of segmentation hypotheses from content of the user input based, at least in part, on a set of parameters;
querying a domain-specific database using each of the plurality of segmentation hypotheses to obtain at least one result; and
modifying at least one of the set of parameters based, at least in part, on the at least one result.
